(19) United States
(12) Patent Application Publication
(10) Pub. No.: US 2008/0229828 A1
(43) Pub. Date: Sep. 25, 2008

(54) Establishing reputation factors for publishing entities

(75) Inventors: Jon M. Buschman, Seattle, WA (US); Yue Liu, Issaquah, WA (US); Qiang Wu, Sammamish, WA (US); Zhen Liu, Sammamish, WA (US); Amir Padovitz, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/725,633

(22) Filed: Mar. 20, 2007

(51) Int. Cl. G01H 13/00

(52) U.S. Cl. 73/579

(57) ABSTRACT

The architecture utilizes the network effects of patents, journals, authors, institutions, and funding entities, for example, to establish an objective reputation factor. The reputation factor contributes to a higher perceived relevance as well as provides interesting new services that could be built on top. The algorithm takes into account not only the number of cited-by references for a certain paper, author, or institution, but can also generate a higher ranking for cross-disciplinary citations, citations establishing a new area of science, acknowledgement citations, and constantly-updated reputation factors of different important entities, such as co-authorship, institutional affiliation, and journal impact factor. Impact factors can be fed back into the system for consideration in generating the reputation factor.

### BACKGROUND

In many professional environments or academic institutions, it is a requirement that high-level employees publish as a means for not only bringing in business and obtaining notoriety, but in the case of academia, for obtaining tenure. Accordingly, there are vast numbers of publications in the public domain.

There are currently several products that utilize cited-by references—research that has cited (referenced) previous scholarly work—in order to provide researchers with a way to link research as well as utilize the citation counts of a work in order to rank search results. However, the way these citations are used in current products are either mysterious and cannot be trusted, or the citations used are not recent enough to keep up with current research thereby retarding the increasingly dynamic nature of the concept of reputation. In other words, systems exist that are not inherently objective, but biased by the very domain in which the authors publish.

Currently the Page-rank™ type of ranking takes advantage of document popularity by using the number of times a certain paper has been cited by other papers. This popularity does not necessarily correlate to prestige within the community. For example, the paper could be cited as an example of something to avoid, or as an example of poor methodology. More importantly, a prestigious paper may not have a lot of citations, simply because it was published more recently. Thus, conventional systems fail to take into account these and many other factors for establishing an objective representation of reputation.

### SUMMARY

The following presents a simplified summary in order to provide a basic understanding of novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture utilizes network effects of patents, journals, authors, institutions, and funding entities, for example, to establish an objective reputation factor for an entity, for example, a document or paper. The reputation factor contributes to a higher perceived relevance as well as providing the capability for new services to be built on top.

The algorithm takes into account not only the number of cited-by references for a certain paper, author, or institution, but can also generate a higher ranking for cross-disciplinary citations, citations establishing a new area of science, acknowledgement citations, and constantly-updated reputation factors of different important entities, such as co-authorship, institutional affiliation, and journal impact factor.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented reputation system in accordance with an embodiment.

FIG. 2 illustrates a client-based reputation processing system in accordance with an embodiment.

FIG. 3 illustrates a client and/or server system for reputation processing in accordance with one implementation.

FIG. 4 illustrates an exemplary embodiment of an access component for finding and accessing network-based citing information in accordance with one implementation.

FIG. 5 illustrates a high-level diagram of an extraction system for reputation factor generation.

FIG. 6 illustrates functionality and processes of the design component of FIG. 5.

FIG. 7 illustrates functionality and processes of the training component of FIG. 5.

FIG. 8 illustrates functionality and processes of the runtime component of FIG. 5.

FIG. 9 illustrates functionality and processes of the testing component of FIG. 5.

FIG. 10 illustrates a high-level diagram of a matching system for reputation factor generation.

FIG. 11 illustrates a method of generating reputation information.

FIG. 12 illustrates a method of a creating a citation graph for a document based on a list of cited references.

FIG. 13 illustrates an alternative method of generating a citation graph.

FIG. 14 illustrates a method of utilizing cross-disciplinary information for reputation processing.

FIG. 15 illustrates a method of utilizing institutional information for reputation processing.

FIG. 16 illustrates a method of reputation processing based on a newly-evolving area of science and/or technology.

FIG. 17 illustrates a method of reputation processing based on a publishing journal.

FIG. 18 illustrates a method of reputation processing based on date of publication.

FIG. 19 illustrates a method of reputation processing based on authorship.

FIG. 20 illustrates a method of reputation processing based on automatically adjusting processing parameters based on learning and reasoning.

FIG. 21 illustrates a block diagram of a computing system for reputation processing in accordance with the disclosed architecture.

FIG. 22 illustrates a schematic block diagram of an exemplary computing environment for reputation processing.

### DETAILED DESCRIPTION

The disclosed architecture facilitates the access and generation of objective reputation information for an entity (e.g., a document, paper, journal, . . . ). Where the entity is a paper, for example, access can be obtained to other sources that provide cite information to the paper. A citation graph is generated, and which graph is utilized to search and assess the value of the citing reference or document. The graph can be a tree where each node is a citing paper and/or institution from which the citing paper was written. Thus, different types of information can be utilized, weighed, prioritized and filtered, for example, to provide an objective assessment of the citing source and to output a final reputation value that represents an objective reputation metric of the particular document being searched. This finds particular application to academia where papers, reputation and prestige play a role in assessing value in a document, entity, and/or individual, for example.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

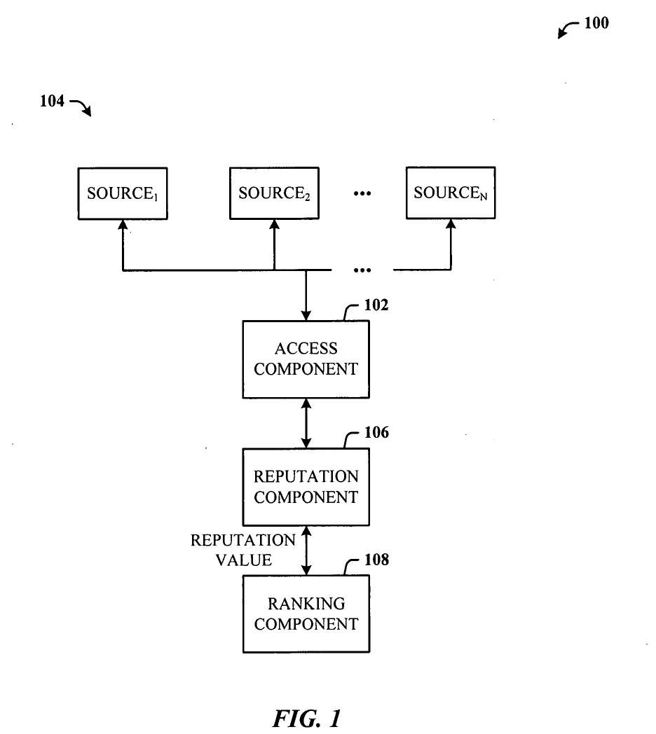

Referring initially to the drawings, FIG. 1 illustrates a computer-implemented reputation system 100 in accordance with an embodiment. The system 100 includes an access component 102 for accessing disparate sources 104 (denoted SOURCE₁, . . . , SOURCE_{N}, where N is a positive integer) of citation information associated with an entity in a community (e.g., academic, professional, business, . . . ). The access component 102 can include algorithms for scanning text-based information such as documents, web sites, web pages, etc., for developing a citation graph of all or many citing references or entities. A reputation component 106 of the system 100 can be provided for computing a reputation value based on quality of the citation information obtained from the sources 104. Based on the reputation value, a ranking component 108 receives and processes the reputation value into rank data for ranking the entity within an academic community.

The sources 104 of citation information can be obtained from patents, journals, authors, institutions, and funding entities, for example, to establish the reputation factor or value. The disclosed algorithm can take into account not only the number of cited-by references for a certain paper, author, or institution, for example, but can consider as a means for generating a higher ranking cross-disciplinary citations, citations establishing a new area of science, acknowledgement citations, and constantly updated reputation factors of different important entities, such as co-authorship, institutional affiliation, and journal impact factor. The system 100 provides an objective mechanism for generating the reputation factor or value, which contributes to a higher perceived relevance. Moreover, new services can be built on top for utilizing the output reputation results.

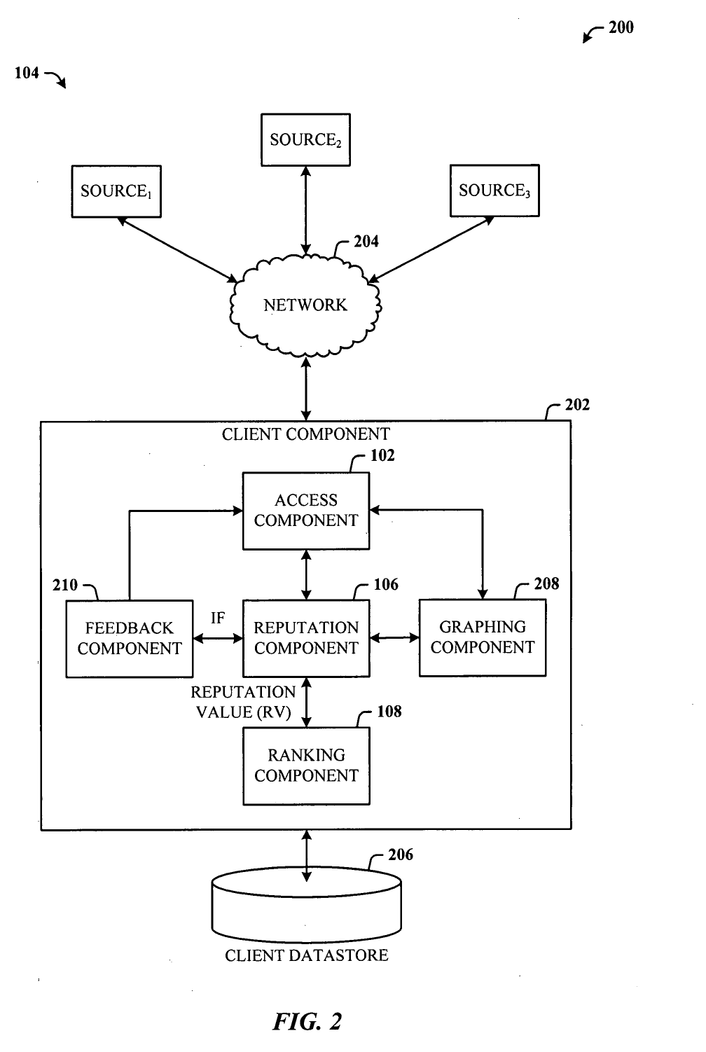

FIG. 2 illustrates a client-based reputation processing system 200 in accordance with an embodiment. Here, the system 200 includes a client 202 (e.g., as part of a computing system) that facilitates access to remote sources 104 and the generation of iteration reputation information as well as a final reputation result based on cited-by references or entities obtained from the sources 104. In this particular implementation, the client 202 can access information from the remote sources 104 disposed on a network 204 (e.g., the Internet, an academic network and a scientific network) and/or a local client datastore 206.

Where the client datastore 206 is utilized, it is to be understood that the client 202 can, in one implementation, receive periodic updates from a provider, for example, such that the client user can search and receive reputation information based on the local citing information received and stored on the client datastore 206. Alternatively, or in combination therewith, the client 202 can receive citing information froth the datastore 206 and then access the remote network sources 104 for updated information. In other words, a citation tree or graph can be generated via a client graphing component 208 initially based on citation information obtained from the local datastore 206, and thereafter, search for updated information on the network 204 based on the locally-based citation graph.

Based on the citation graph of the graphing component 208, the reputation component 106 can generate a final reputation value based on a single iteration or multiple iterations of searching, accessing, and processing the citing information obtained, either from the local datastore and/or the sources 104. In one operative embodiment, the final reputation value is used by the ranking component 108 to rank the desired entity (e.g., paper, journal) according to a domain in which the paper is normally reviewed. In other words, a research paper could be ranked in the scientific community as well as academia.

In an alternative embodiment, the reputation value (RV) and/or other impact factors can be fed back into the access component 102 via a feedback component 210. Thus, based on each iteration or a fixed number of iterations, for example, an impact factor (IF) can be fed back for additional processing in combination with new source information. In other words, where one or more of the sources 104 accessed for a search are deemed less than objective according to some criteria, this criteria can be applied to the information received from the less objective sources to give the citing information received for those sources less credibility in the overall process for reputation value generation.

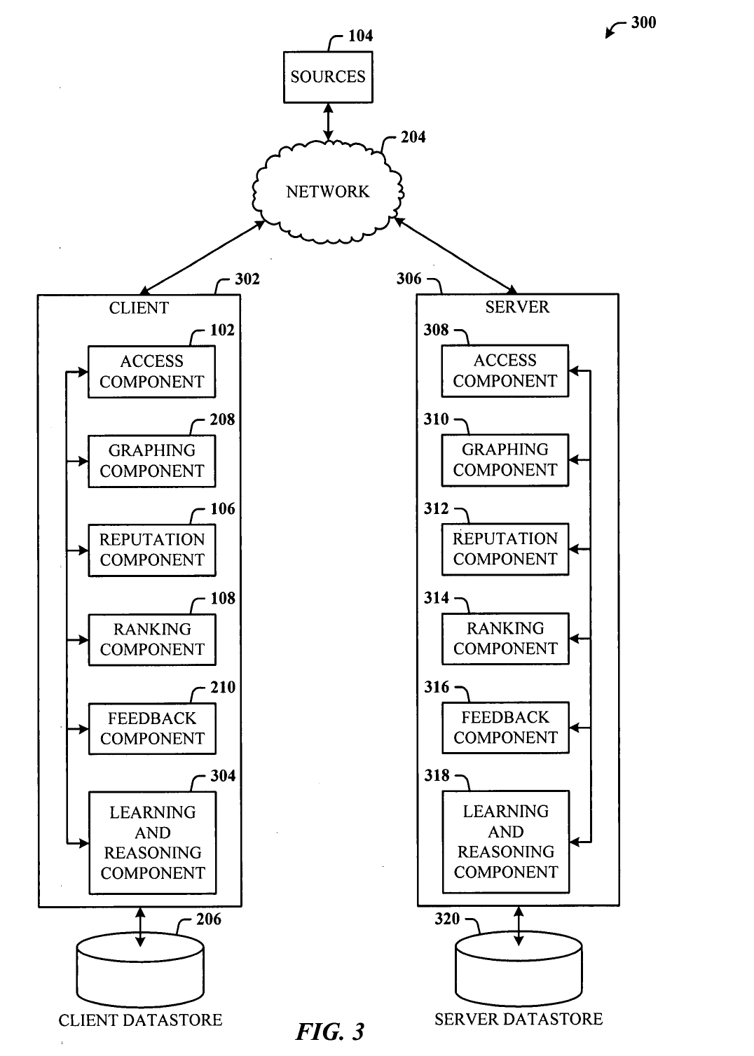

FIG. 3 illustrates a client and/or server system 300 for reputation processing in accordance with one implementation. The system 300 can include a client 302 that comprises one or more of the components of the client of FIG. 2, but in a different connective orientation, where each component connects to the other components. The client 302 can include the access component 102 for access processing of the sources 104 on the network 204, the graphing component 208 for generating a citation graph, reputation component 108 for generating the reputation value based on the citations obtained and processed, the feedback component 210 for feeding information back into at least reputation processing, and the ranking component 108 for providing a ranked output of information based on the reputation value(s).

Here, the client 302 can also include learning and reasoning functionality via a learning and reasoning (LR) component 304 for automating one or more features. The LR component 304 can monitor client processes and data, and based on those observations, make automated adjustments to client operations.

The subject architecture (e.g., in connection with selection) can employ various LR-based schemes for carrying out various aspects thereof. For example, a process for determining which of the many sources 104 to select for sampling, for example, can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence (class(x)). Such classification can employ a probabilistic and/or other statistical analysis (e.g., one factoring into the analysis utilities and costs to maximize the expected value to one or more people) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, for example, various forms of statistical regression, naïve Bayes, Bayesian networks, decision trees, neural networks, fuzzy logic models, and other statistical classification models representing different patterns of independence can be employed. Classification as used herein also is inclusive of methods used to assign rank and/or priority.

As will be readily appreciated from the subject specification, the subject architecture can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria.

The LR component 304 can monitor and reason about data sources such as for determining if the client reputation system should search the client datastore 206 for the desired reputation information, the network sources 104, or a combination thereof. Moreover, the LR component 304 can learn and adjust times for automatically updating the client datastore 206 where citing information is downloaded thereto for access and reputation value derivation at a later time (e.g., by the client user).

In another implementation, the client LR component 304 can be employed to monitor client reputation value generation processes, and based on this data, choose new sources 104 for cited-by references or other related information. For example, if it is learned that one of the sources 104 routinely provides low quality citing references, the LR component 304 can cause new sources to be accessed and analyzed. The access component 102 of the client 302 can be employed to store a primary set of source location information (e.g., web addresses) and a secondary set of source location information. If one or more of the primary locations drop offline or are removed or changed the access component 102 can be controlled by the LR component 304 to pull addresses of one or more secondary sources for searching.

Alternatively, or in combination therewith, a server 306 can be employed which includes server-side adaptations of an access component 308 for access processing of the sources 104 on the network 204, a graphing component 310 for generating a citation graph, a reputation component 312 for generating the reputation value based on the citations obtained and processed, a feedback component 316 for feeding information back into at least reputation processing, and a ranking component 314 for providing a ranked output of information based on the reputation value(s).

The server 306 can also include learning and reasoning via a server-side adaptation of an LR component 318 for automating one or more features. The LR component 318 can monitor server processes and data, and based on those observations, make automated adjustments to the server operations.

The server LR component 318 can monitor and reason about data sources such as for determining if the server reputation system should search a server datastore 320 for the desired reputation information, the network sources 104, or a combination thereof. Moreover, the LR component 318 can learn and adjust times for automatically updating the server datastore 320 where citing information is downloaded thereto for access and reputation value derivation at a later time (e.g., by the client user).

In another implementation, the client LR component 304 can be employed to monitor client reputation value generation processes, and based on this data, choose new sources 104 for cited-by references or other related information. For example, if it is learned that one of the sources 104 routinely provides low quality citing references, the LR component 318 can cause new sources to be accessed and analyzed. The access component 308 of the server 306 can be employed to store a primary set of source location information (e.g., web addresses) and a secondary set of source location information. If one or more of the primary locations drop offline or are removed or changed the access component 308 can be controlled by the LR component 318 to pull addresses of one or more secondary sources for searching.

It is within contemplation of the subject architecture that the client 302 and/or the server 306 can also search sources 104 that can include other client systems for quality cited-by references or relevant information. For example, it can be desirable to search only sources that routinely provide quality reference information; however, reference information can be in-process in client machines of highly reputable individuals, and which can be accessed under suitable conditions.

Training can be by the user reviewing the returned references or publications and manually providing feedback by way of correcting, eliminating or adding other sources or references, for example.

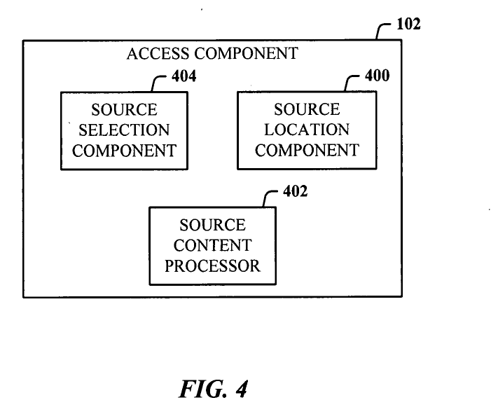

FIG. 4 illustrates an exemplary embodiment of an access component (e.g. the component 102 of FIG. 1) for finding and accessing network-based citing information, in accordance with one implementation. Although illustrated as access component 102 for the client 302, the server-side implementation of the access component 308 also applies. The access component 102 can be a web interface that includes a source location component 400 that includes location information such as addresses (e.g., IP addresses, URL links, etc.) to network sources of information. For example, one of the sources of published documents can be a scientific or engineering website such as the Institute of Electrical and Electronic Engineers (IEEE) which can provide a wide variety of papers for various scientific disciplines. Another of the sources can be an academic web site or resource (e.g., Massachusetts Institute of Technology, California Institute of Technology) which could be considered reputable in the domain of scientific and/or academic publications, for example. However, the disclosed architecture can factor in the changing dynamics in the quality and reputations of the sources as well as the reputations of the associated source information or documents.

The access component 102 can also include a source selection component 402 for selecting the source(s) based on the location information provided by the location component 400. Selection of the source(s) can be based on preconfigured settings that route all search requests to a local datastore (e.g., the client datastore 206 and/or server datastore 320 of FIG. 3) and/or network sources.

The access component 102 can also include a source content processor 404 that provides the capability of processing the obtained information into a suitable format for reputation process thereafter. For example, it is likely that most information obtained will be in the form of text. However, if documents that are linked-to as part of a citation graph are in a PDF (portable document format) format, for example, the content processor 404 can perform OCR (optical character recognition) of the document to obtain textual information therefrom for reputation processing, if content processing is to be part of the reputation value generation process. In more robust embodiments, the source content processor 404 can also perform image recognition (for image files), voice recognition (for audio files), video recognition (for video files), and so on.

The following figures illustrate methodologies for generating reputation information based on sources, impact factors, learning and reasoning, and reference quality, for example. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

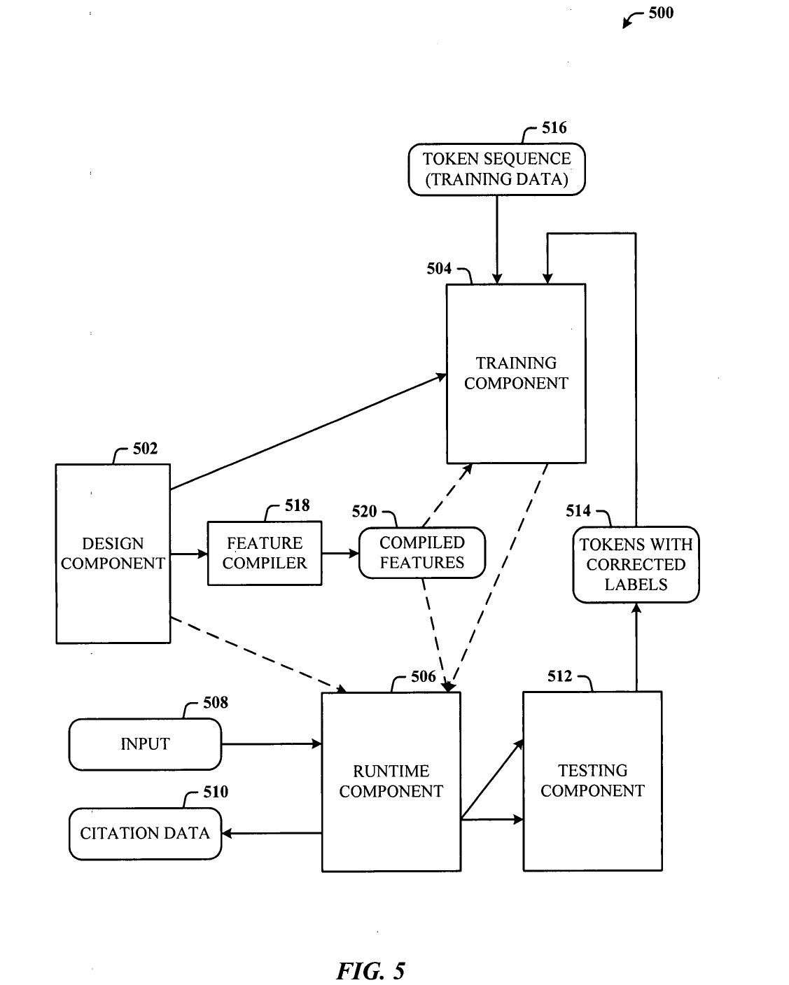

FIG. 5 illustrates a high-level diagram of an extraction system 500 for reputation factor generation. The extraction system 500 takes unstructured data as an input and outputs structured data. The system 500 includes four main components: a design component 502 for definition processing, a training component 504 for receiving training data and outputting trained parameters, a runtime component 506 for using the trained parameters for processing documents and data (from a document input 508), and a testing component 512 for receiving data from the runtime component 506 and forwarding the data through a label correction process 514 to the training component 504. The training component 504 can also receive training data in the form of token sequences 516. An output of the design component 502 is feature information that is passed to a feature compiler 518 for output as compiled features 520 to both the training component 504 and the runtime component 506. Output of the training component 504 is also passed to the runtime component 506.

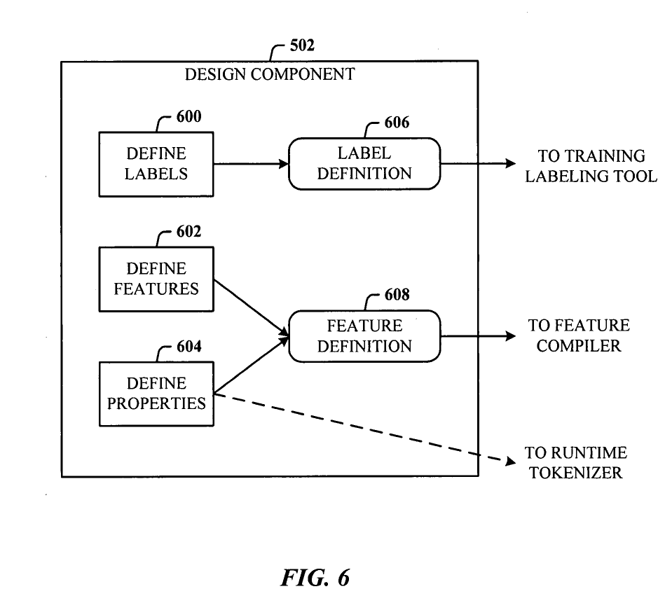

The main components (502, 504, 506 and 512) will now be described in greater detail. FIG. 6 illustrates functionality and processes of the design component 502 of FIG. 5. The design component 502 includes a label process 600 for defining labels, a features process 602 for defining features and a properties process 604 for defining properties. The defined labels 600 are input to a label definition process 608 for output to the training component 504 of FIG. 5. The defined features 602 and defined properties 604 are input to a features definition process 608 for compiling by the feature compiler 518 of FIG. 5. Additionally, the defined properties 604 are passed to the runtime component 506 of FIG. 5 for runtime processing.

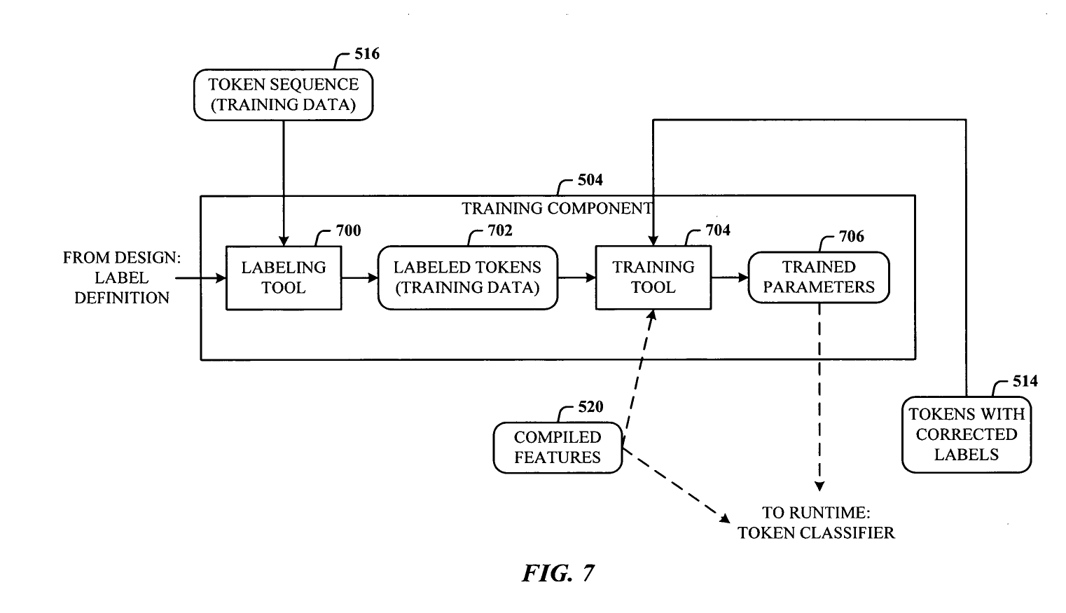

FIG. 7 illustrates functionality and processes of the training component 504 of FIG. 5. The training component 504 includes a labeling tool 700 for labeling data based in label definitions 606 received from the design component 502, and token sequence data 516 received as training data. An output of the labeling tool 700 is labeled tokens 702, which can be used as training data for input to a training tool 704. The training tool 704 can also receive the tokens with corrected labels 514 from the testing component 512 of FIG. 5, as well as the compiled features 520. Output of the training tool 704 are trained parameters 706 which are passed to the runtime component 506 for classification processing. As indicated, the compiled features 520 can also be passed to the runtime component 506 for classification processing.

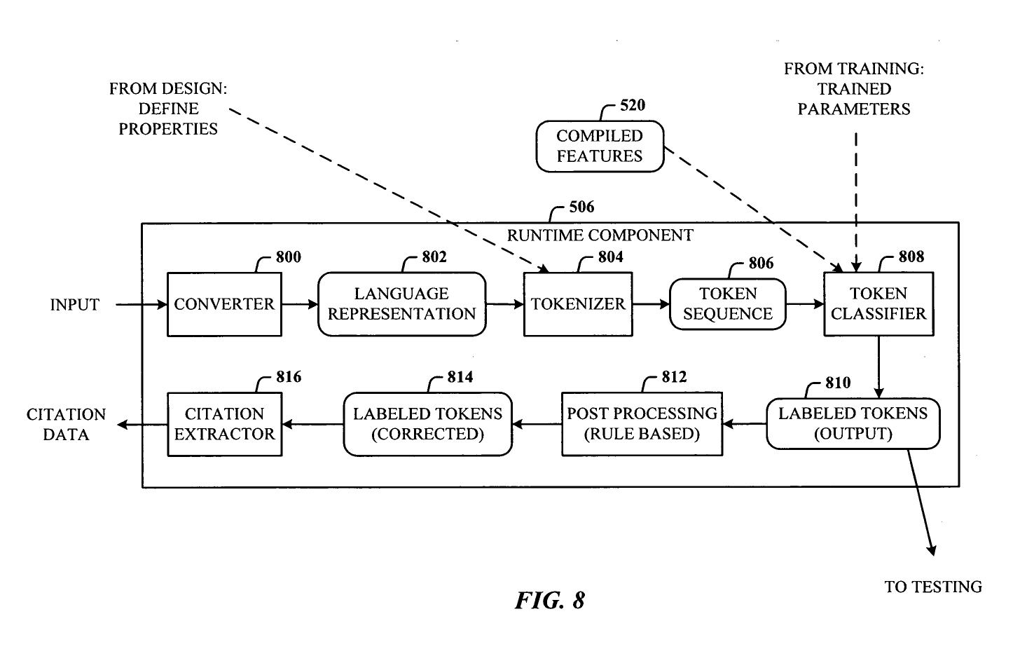

FIG. 8 illustrates functionality and processes of the runtime component 506 of FIG. 5. The runtime component 506 includes a converter 800 for converting the input (e.g., input 508 of FIG. 5). In one embodiment, the input includes a PDF document for conversion into a language representation 802 (e.g., XML). The representation 802 is passed into a tokenizer 804, which also receives defined properties (e.g., properties 604 of FIG. 6) for processing into a token sequence 806. The token sequence 806 is input to a token classifier 808, as well as the compiled features 520 and the trained parameters 706 of FIG. 7.

The output of the classifier 808 is one or more labeled tokens 810, which tokens then undergo post processing 812 (e.g., rules based) for output as labeled tokens 814. The labeled tokens are processed by a citation extractor 816, the out of which is citation data. The labeled tokens 810 are also passed to the testing component 512 of FIG. 5.

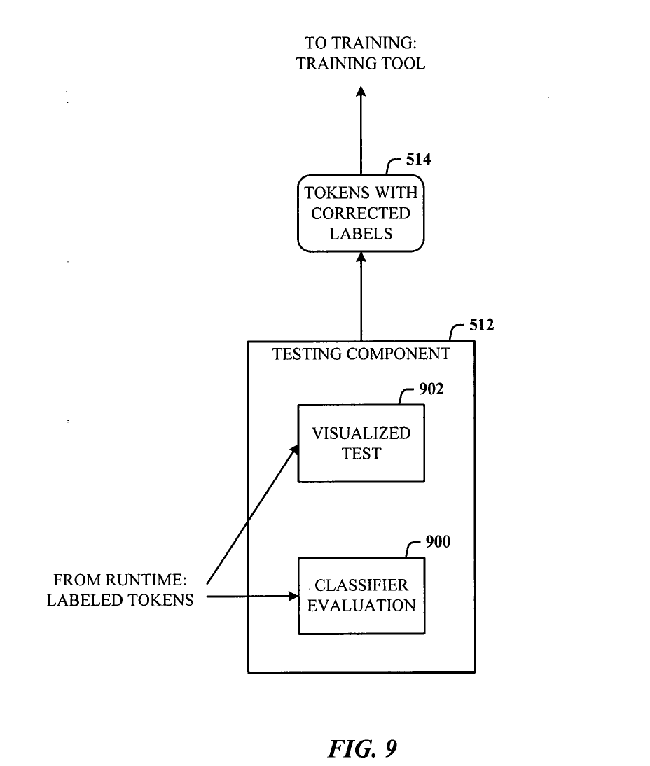

FIG. 9 illustrates functionality and processes of the testing component 512 of FIG. 5. The testing component 512 includes a classifier evaluation process 900 for performing analysis on the labeled tokens 810 of the runtime component 506 of FIG. 8. The labeled tokens 810 are also passed to a visualized test process 902 of the testing component 512 for receiving user feedback on the labeled results from the runtime component 506. As indicated before, output of the testing component 512 is the tokens with correct labels 514, which are forwarded to the training tool 704 of the training component 504 of FIG. 7.

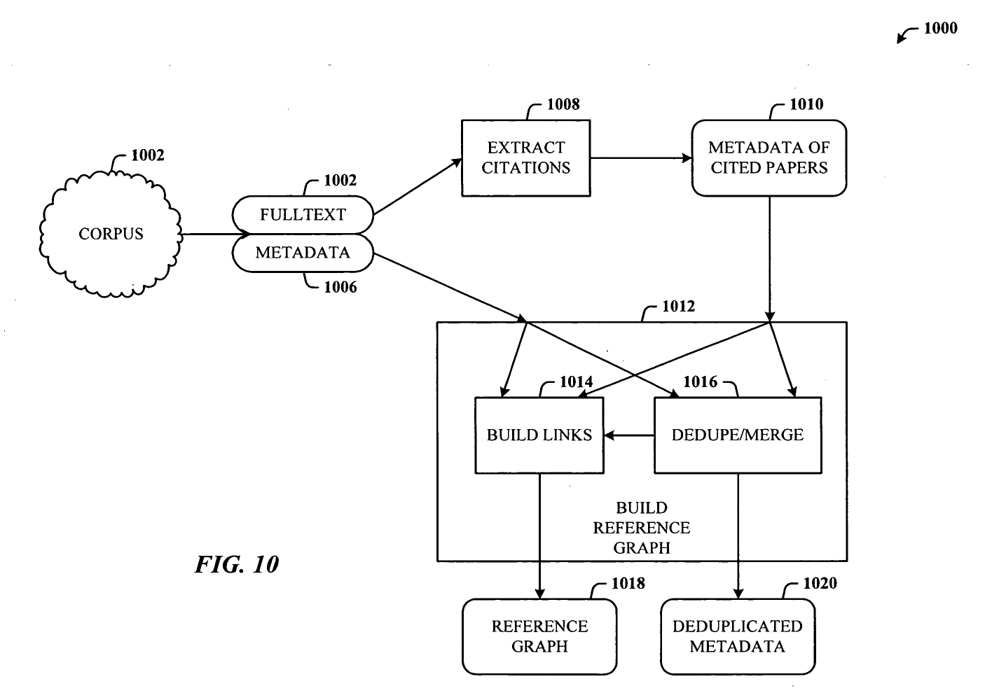

FIG. 10 illustrates a high-level diagram of a matching system 1000 for reputation factor generation. The system 1000 includes a corpus 1002 of information (e.g., the sources 104 of FIG. 1) from the reputation factor will be generated. Selected from the corpus 1002 can full text (e.g., paper discussions, abstract, tests, analysis, conclusions, and references) of documents 1004 in different formats (e.g., text, PDF, etc.) and attached metadata 1006. From the full text documents 1002 citation metadata 1010 (e.g., a References section at the end of the paper that lists cited references) can be extracted using a citation extraction process 1008. The metadata 1010 can include author, title, journal in which document was or is to be published, dates, issues volume, publisher, page numbers, etc. The metadata 1006 from the corpus 1002 and metadata 1010 from the cited papers are then utilized to build a reference (or citation) graph via a graphing process 1012.

The graphing process 1012 includes a link building process 1014 for building links in the graph to known matches, and a de-duplication process 1016 for eliminating duplications in the metadata for the corpus 1002 and the metadata 1010 of the cited papers. This also facilitates matching the extracted citations data 1010 with real documents from the corpus 1002 or other sources. Once de-duplicated, the metadata (1006 and 1010) is then merged 1016. An output of the graphing process 1012 is a reference (or citation) graph 1018 and de-duplicated metadata 1020. The graph building process 1012 will build a mesh graph having multiple nodes with multiple connections to other nodes (e.g., a many-to-many relationship). As the corpus 1002 grows it is possible to multiple entries for the same document. Thus, these duplications are addressed by the de-duplication process 1016. Moreover, the location of these duplicates can be considered as an impact factor (good or bad) that can be given a weighting for ultimately computing the reputation factor of the document.

The corpus 1002 can be data that is indexed on a closed system (e.g., system 100) and which includes full text documents in different formats (e.g., text, PDF, . . . ) and attached metadata. In an alternative embodiment, the corpus 1002 can include data/document sources (e.g., web sites) that are accessible on public networks such as the Internet. The matching system 1000 can also be used to increase the corpus 1002. For example, if there are extracted citations that are unmatched (which there will be because there can be papers that reference other documents outside the corpus 1002), these unmatched citations are candidates for bringing into the corpus. Moreover, at the end of the reputation process, if a reputation value for a document exceeds predetermined criteria, the associated document can be added to the corpus 1002. This can also be subject to licensing criteria, etc.

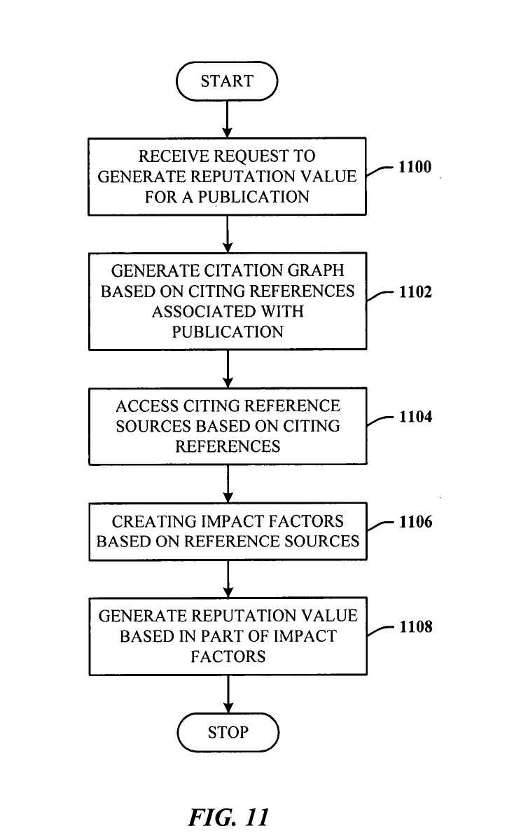

FIG. 11 illustrates a method of generating reputation information. At 1100, a request is received to generate a reputation value for a publication. At 1102, a citation graph is generated based on citing references associated with the publication. At 1104, one or more reference sources are accessed based on the citing references. At 1106, impact factors based on the reference sources are created. At 1108, the reputation value is generated based in part on the impact factors.

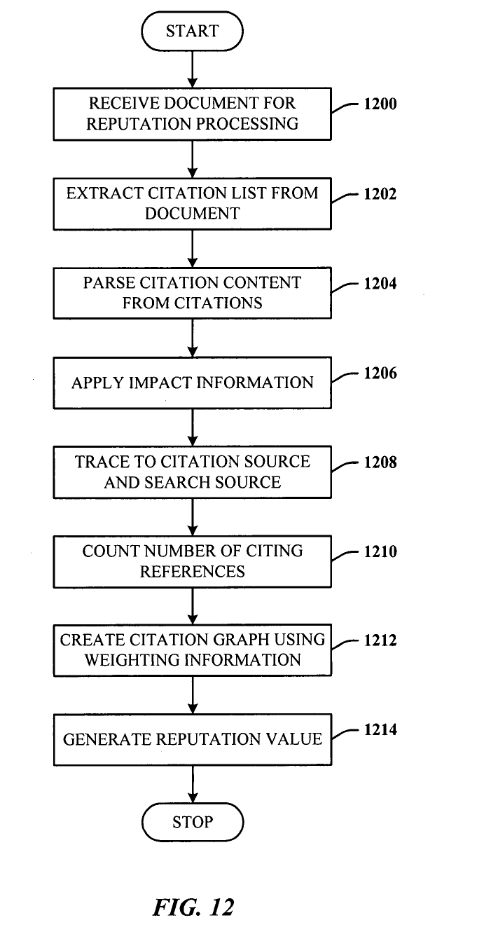

FIG. 12 illustrates a method of a creating a citation graph for a document based on the list of cited references. At 1200, a document is received for reputation processing. At 1202, the system extracts the citation list (or citing references) for the document. At 1204, the system parses citation content from the citations of list. For example, generally, this can include the citation author(s), citation title, and/or citation source information. This can also include the country and date of the citation. At 1206, impact information (weighting information) can be assigned to the citation, in general, or to each of the citation content parsed. For example, if it is known or has been previously developed that the source of the citation is associated with high quality information, the impact factor for this citation can be high. At 1208, the system traces back to the cited reference source and searches the source for references that cite this document. For example, if one of the cited references is an IEEE reference, the IEEE datastore can be accessed via a network. At 1210, the number of cited references in this document can be considered as well. At 1212, the search results for the citing references can be added to the citation graph with weighting information added at each node. Ultimately, the system determines that the citation graph is sufficiently large, and processes the graph to generate at the reputation value, as indicated at 1214.

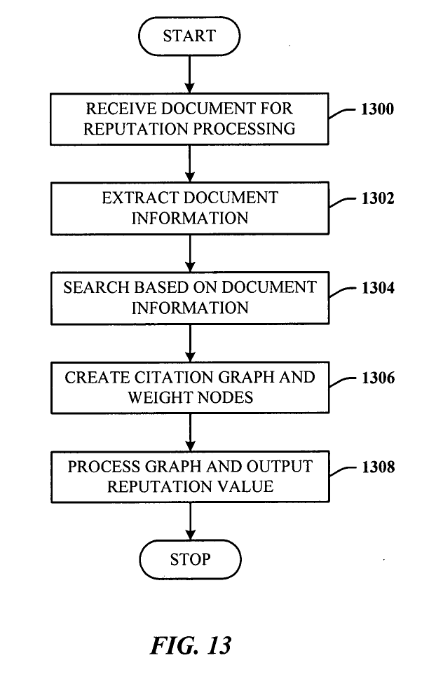

FIG. 13 illustrates an alternative method of generating a citation graph. At 1300, a publication is received for reputation processing. At 1302, document information in the form of the title, author(s), and/or publication source are extracted. At 1304, using all or part of this document information, a search is performed against a data repository of reputation information. At 1306, a citation graph is developed and one or more of the graph nodes weighted. At 1308, the graph is processed to output the reputation value.

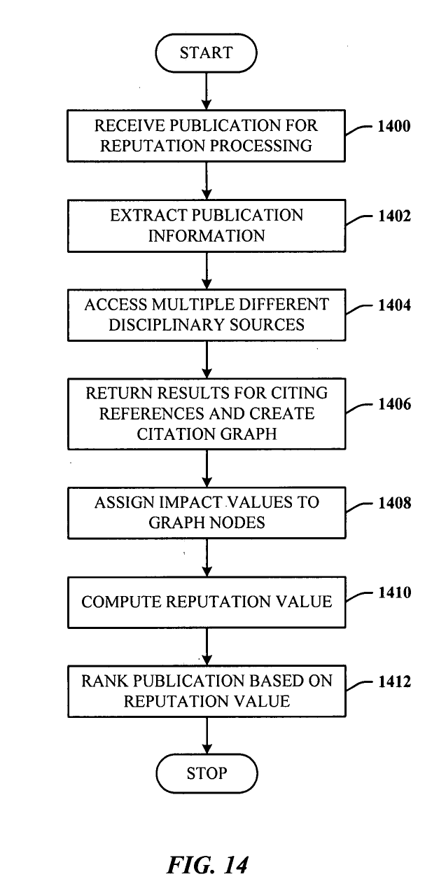

FIG. 14 illustrates a method of utilizing cross-disciplinary information for reputation processing. At 1400, a publication is received for processing. At 1402, the user enters publication information such as title, author(s), date, and/or source information into the reputation processing engine. At 1404, the engine processes the publication information by accessing multiple different disciplinary datastores or libraries. At 1406, the results for citing references from the various disciplines are returned and a citation graph developed. At 1408, the citation nodes are assigned impact values. At 1410, the overall reputation value is computed and output. At 1412, the reputation value is used to rank the publication among one discipline or for each discipline searched.

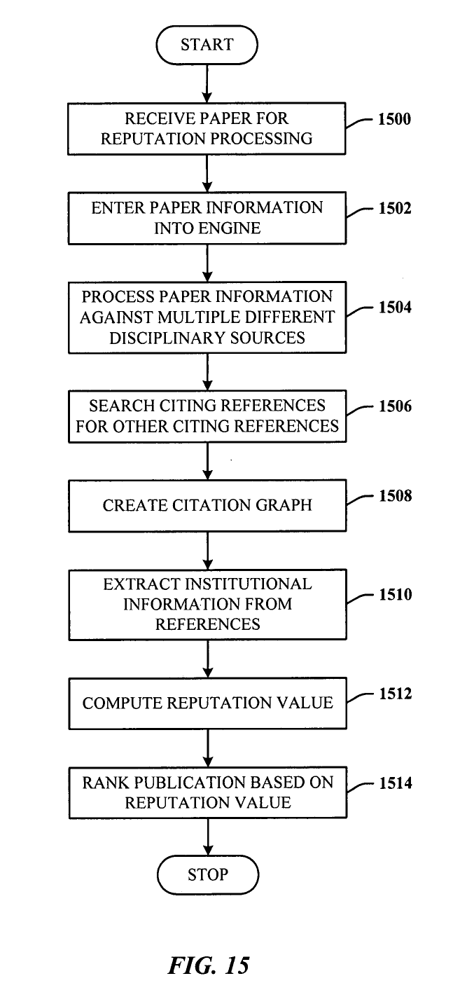

FIG. 15 illustrates a method of utilizing institutional information for reputation processing. At 1500, a paper is received for reputation processing. At 1502, the user enters paper information such as title, author(s), date, and/or source information into the reputation processing engine. At 1504, the engine processes the paper information against one or more datastores or modules of reference information to obtain a list of citing references. At 1506, the citing references are further searched for citing references. At 1508, a citation graph is created of all available citing references. At 1510, institutional information for each citing reference is extracted, rated, and processed. At 1512, the final reputation value is generated and output. At 1514, the paper is ranked based on the reputation value.

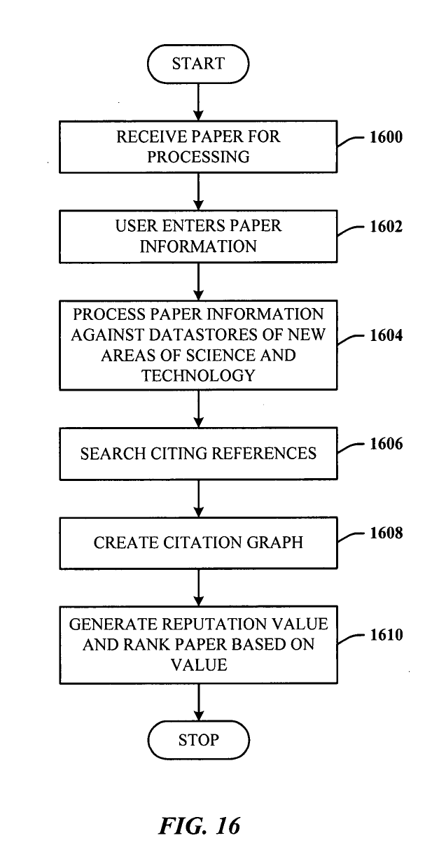

FIG. 16 illustrates a method of reputation processing based on a newly-evolving area of science and/or technology. At 1600, a paper is received for reputation processing. At 1602, the user enters paper information such as title, author(s), date, and/or source information into the reputation processing engine. At 1604, the engine processes the paper information against one or more datastores or modules of reference information related to new-evolving areas of science and technology to obtain a list of citing references. At 1606, the citing references are further searched for citing references. At 1608, a citation graph is created of all available citing references. At 1610, a final reputation value is generated and output based on citing references to the paper from the new areas of science and technology and the paper is ranked based on the reputation value.

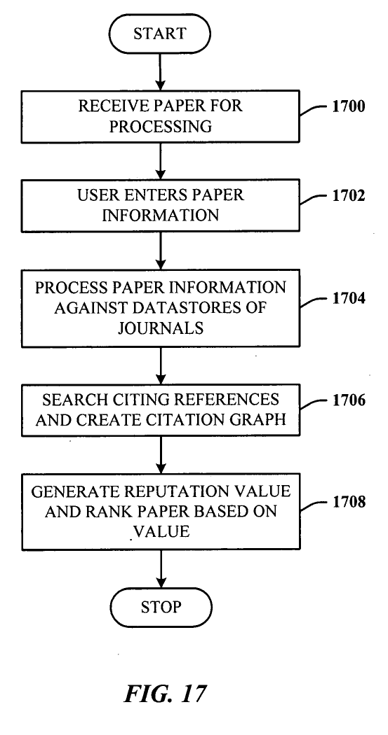

FIG. 17 illustrates a method of reputation processing based on a publishing journal. At 1700, a paper is received for reputation processing. At 1702, the user enters paper information such as title, author(s), date, and/or source information into the reputation processing engine. At 1704, the engine processes the paper information against one or more datastores or modules of reference information related to journals in which documents are published. At 1706, the citing references are further searched for citing references and a citation graph is created of all available citing references. At 1708, a final reputation value is generated and output based on journals in which the citing references to the paper are published and the paper is ranked based on the reputation value.

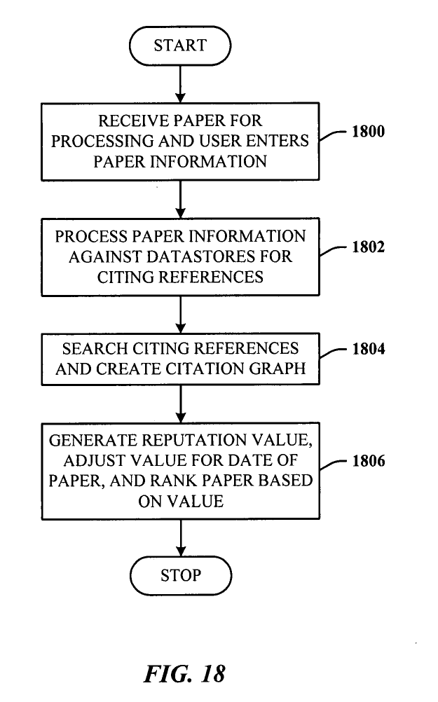

FIG. 18 illustrates a method of reputation processing based on date of publication. At 1800, a paper is received and the user enters paper information such as title, author(s), date, and/or source information into the reputation processing engine. At 1802, the engine processes the paper information against one or more datastores or modules of reference information to find citing references. At 1804, the citing references are further searched for citing references and a citation graph is created of all available citing references. At 1806, a final reputation value is generated and output based on a limited set of citing references, but adjusted for the date of publication, and the paper is ranked based on the reputation value.

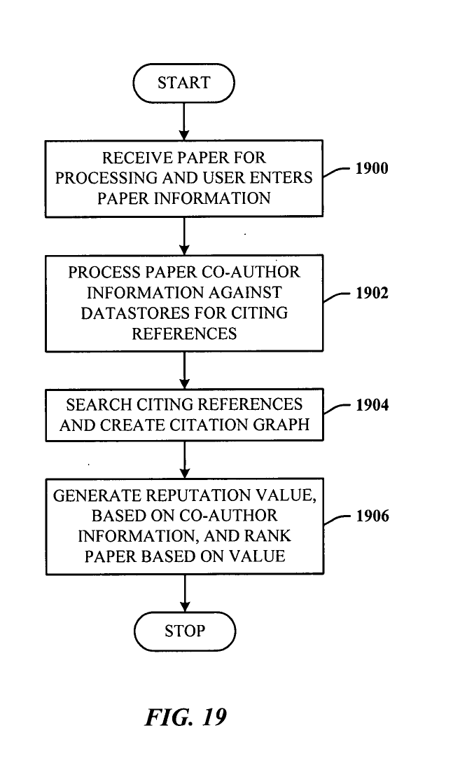

FIG. 19 illustrates a method of reputation processing based on authorship. At 1900, a paper is received and the user enters paper information such as title, author(s), date, and/or source information into the reputation processing engine. At 1902, the engine processes the co-author information against one or more datastores or modules of reference information to find citing references. At 1904, the citing references are further searched for citing references and a citation graph is created of all available citing references. At 1906, a final reputation value is generated and output based on the co-authors and citing references to the co-authors, and the paper is ranked based on the reputation value.

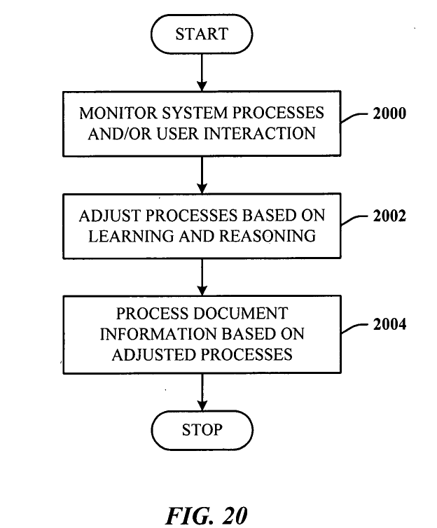

FIG. 20 illustrates a method of reputation processing based on automatically adjusting processing parameters based on learning and reasoning. At 2000, system processes, search methods and results, datastore updates and processes, user interactions, historical reputation processing, and other process are monitored. At 2002, based on processes that are performed substantially repetitively and that are different than programmed processes, learning and reasoning automatically adjusts processes for more efficient and effective engine and user interaction. At 2004, the document information received for reputation evaluation is processed according to the adjusted processes.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

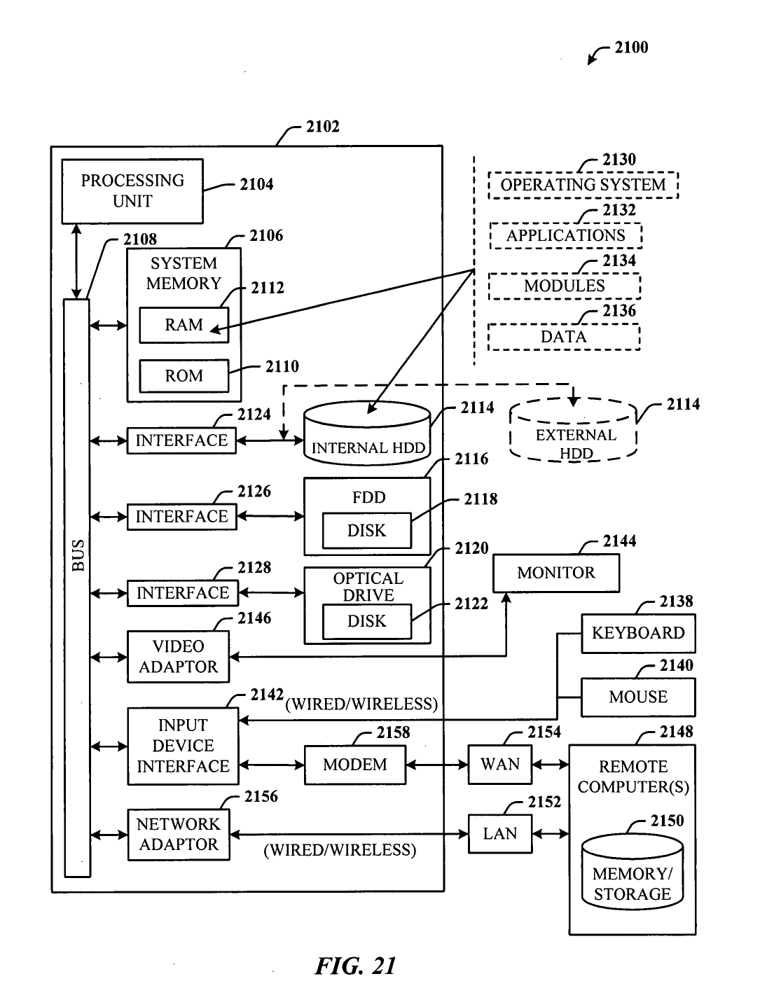

Referring now to FIG. 21, there is illustrated a block diagram of a computing system 2100 for reputation processing in accordance with the disclosed architecture. In order to provide additional context for various aspects thereof, FIG. 21 and the following discussion are intended to provide a brief, general description of a suitable computing system 2100 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 21, the exemplary computing system 2100 for implementing various aspects includes a computer 2102, the computer 2102 including a processing unit 2104, a system memory 2106 and a system bus 2108. The system bus 2108 provides an interface for system components including, but not limited to, the system memory 2106 to the processing unit 2104. The processing unit 2104 can be any of various commercially available processors. Dual microprocessors and other multi-processor architectures may also be employed as the processing unit 2104.

The system bus 2108 can be any of several types of bus structure that may further interconnect to a memory bus (with or without a memory controller), a peripheral bus, and a local bus using any of a variety of commercially available bus architectures. The system memory 2106 includes read-only memory (ROM) 2110 and random access memory (RAM) 2112. A basic input/output system (BIOS) is stored in a non-volatile memory 2110 such as ROM, EPROM, EEPROM, which BIOS contains the basic routines that help to transfer information between elements within the computer 2102, such as during start-up. The RAM 2112 can also include a high-speed RAM such as static RAM for caching data.

The computer 2102 further includes an internal hard disk drive (HDD) 2114 (e.g., EIDE, SATA), which internal hard disk drive 2114 may also be configured for external use in a suitable chassis (not shown), a magnetic floppy disk drive (FDD) 2116, (e.g., to read from or write to a removable diskette 2118) and an optical disk drive 2120, (e.g., reading a CD-ROM disk 2122 or, to read from or write to other high capacity optical media such as the DVD). The hard disk drive 2114, magnetic disk drive 2116 and optical disk drive 2120 can be connected to the system bus 2108 by a hard disk drive interface 2124, a magnetic disk drive interface 2126 and an optical drive interface 2128, respectively. The interface 2124 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 2102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 2112, including an operating system 2130, one or more application programs 2132, other program modules 2134 and program data 2136. All or portions of the operating system, applications, modules, and/or data can also be cached in the RAM 2112. It is to be appreciated that the disclosed architecture can be implemented with various commercially available operating systems or combinations of operating systems.

The applications 2132 and/or modules 2134 can include the components described herein, such as the access component 102, reputation component 106, ranking component 108, graphing component 208, feedback component 210, and LR component 304.

A user can enter commands and information into the computer 2102 through one or more wire/wireless input devices, for example, a keyboard 2138 and a pointing device, such as a mouse 2140. Other input devices (not shown) may include a microphone, an IR remote control, a joystick, a game pad, a stylus pen, touch screen, or the like. These and other input devices are often connected to the processing unit 2104 through an input device interface 2142 that is coupled to the system bus 2108, but can be connected by other interfaces, such as a parallel port, an IEEE 1394 serial port, a game port, a USB port, an IR interface, etc.

A monitor 2144 or other type of display device is also connected to the system bus 2108 via an interface, such as a video adapter 2146. In addition to the monitor 2144, a computer typically includes other peripheral output devices (not shown), such as speakers, printers, etc.

The computer 2102 may operate in a networked environment using logical connections via wire and/or wireless communications to one or more remote computers, such as a remote computer(s) 2148. The remote computer(s) 2148 can be a workstation, a server computer, a router, a personal computer, portable computer, microprocessor-based entertainment appliance, a peer device or other common network node, and typically includes many or all of the elements described relative to the computer 2102, although, for purposes of brevity, only a memory/storage device 2150 is illustrated. The logical connections depicted include wire/wireless connectivity to a local area network (LAN) 2152 and/or larger networks, for example, a wide area network (WAN) 2154. Such LAN and WAN networking environments are commonplace in offices and companies, and facilitate enterprise-wide computer networks, such as intranets, all of which may connect to a global communications network, for example, the Internet.

When used in a LAN networking environment, the computer 2102 is connected to the local network 2152 through a wire and/or wireless communication network interface or adapter 2156. The adaptor 2156 may facilitate wire or wireless communication to the LAN 2152, which may also include a wireless access point disposed thereon for communicating with the wireless adaptor 2156.

When used in a WAN networking environment, the computer 2102 can include a modem 2158, or is connected to a communications server on the WAN 2154, or has other means for establishing communications over the WAN 2154, such as by way of the Internet. The modem 2158, which can be internal or external and a wire and/or wireless device, is connected to the system bus 2108 via the serial port interface 2142. In a networked environment, program modules depicted relative to the computer 2102, or portions thereof, can be stored in the remote memory/storage device 2150. It will be appreciated that the network connections shown are exemplary and other means of establishing a communications link between the computers can be used.

The computer 2102 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, for example, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

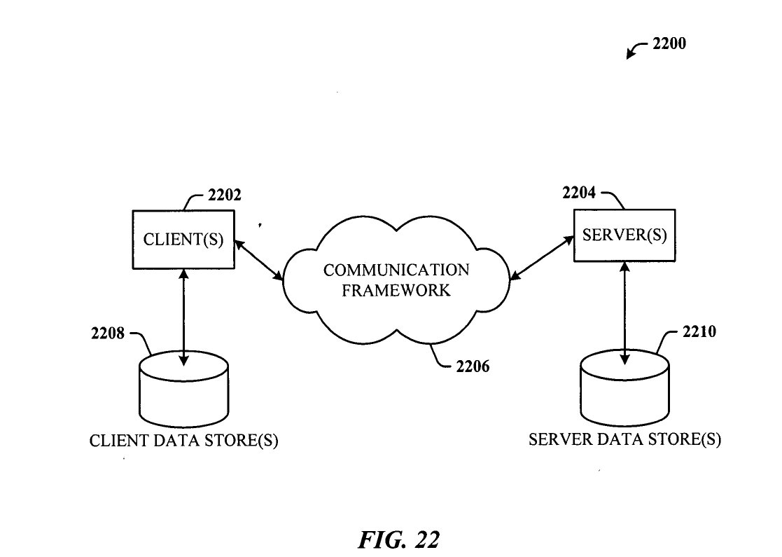

Referring now to FIG. 22, there is illustrated a schematic block diagram of an exemplary computing environment 2200 for reputation processing. The system 2200 includes one or more client(s) 2202. The client(s) 2202 can be hardware and/or software (e.g., threads, processes, computing devices). The client(s) 2202 can house cookie(s) and/or associated contextual information, for example.

The system 2200 also includes one or more server(s) 2204. The server(s) 2204 can also be hardware and/or software (e.g., threads, processes, computing devices). The servers 2204 can house threads to perform transformations by employing the architecture, for example. One possible communication between a client 2202 and a server 2204 can be in the form of a data packet adapted to be transmitted between two or more computer processes. The data packet may include a cookie and/or associated contextual information, for example. The system 2200 includes a communication framework 2206 (e.g., a global communication network such as the Internet) that can be employed to facilitate communications between the client(s) 2202 and the server(s) 2204.

Communications can be facilitated via a wire (including optical fiber) and/or wireless technology. The client(s) 2202 are operatively connected to one or more client data store(s) 2208 that can be employed to store information local to the client(s) 2202 (e.g., cookie(s) and/or associated contextual information). Similarly, the server(s) 2204 are operatively connected to one or more server data store(s) 2210 that can be employed to store information local to the servers 2204.

The clients 2202 can include the client component 202, client 302, and one or more of the sources 104 where the source is a client system. The servers 2204 can include the server 306 for server-side processing of the reputation information and entity ranking.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented reputation system, comprising:
an access component for accessing a source of citation information associated with an entity of a community; and
a reputation component for computing a reputation value based on quality of the citation information.

2. The system of claim 1, further comprising a ranking component for receiving and processing the reputation value into rank data for ranking the entity, which is a publication within an academic community.

3. The system of claim 1, further comprising a feedback component for feeding an impact factor to the access component from a first search iteration.

4. The system of claim 1, wherein the access component accesses citation information related to at least one of patents, journals, authors, institutions, or funding entities for generation of the reputation value.

5. The system of claim 1, wherein the access component accesses citation information related to at least one of cross-disciplines, a new area of science, acknowledgment citations or continuously-updated reputation factors for generation of the reputation value.

6. The system of claim 5, wherein the continuously-updated reputation factors include data related to co-authorship, institutional affiliation, and a journal impact factor.

7. The system of claim 6, wherein a ranking of the entity is increased based on the data related to co-authorship, institutional affiliation, and a journal impact factor.

8. The system of claim 1, further comprising a graphing component for generating a citation graph based on an input request for the reputation information associated with the entity.

9. The system of claim 1, wherein the source includes at least one of a website datastore, client datastore, or server datastore.

10. The system of claim 1, wherein the access component facilitates access to citation information from a source that includes multiple disparate data locations, the citation information in the format of text, an image, audio data, or video data.

11. The system of claim 1, further comprising a learning and reasoning component that employs a probabilistic and/or statistical-based analysis to prognose or infer an action that is desired to be automatically performed.

12. A computer-implemented method of generating reputation information, comprising:
receiving a request to generate a reputation value for a publication;
generating a citation graph based on citing references associated with the publication;
accessing reference sources based on the citing references;
creating impact factors based on the reference sources; and
generating the reputation value based in part on the impact factors.

13. The method of claim 12, further comprising processing cross-disciplinary citations to generate the reputation value.

14. The method of claim 12, further comprising ranking the publication based on the reputation value.

15. The method of claim 12, further comprising generating the reputation value based on a number of the citing references of the publication, an author of the publication, and an institution associated with the publication.

16. The method of claim 12, further comprising generating the reputation value based on a type of citing reference.

17. The method of claim 12, further comprising weighting a citing reference prior to processing the weighted reference into the reputation value.

18. The method of claim 12, further comprising selecting the citing references from a network source or a local datastore.

19. The method of claim 12, further comprising generating the reputation value based on a count of citing references.

20. A computer-implemented system, comprising:
computer-implemented means for receiving a request to generate a reputation value for a publication;
computer-implemented means for generating a citation graph based on citing references associated with the publication;
computer-implemented means for accessing reference sources based on the citing references;
computer-implemented means for creating impact factors based on the reference sources; and
computer-implemented means for generating the reputation value based in part on the impact factors.
